(19) United States
(12) Patent Application Publication
(10) Pub. No.: US 2006/0208090 A1
(43) Pub. Date: Sep. 21, 2006

(54) Encoding labels without use of ink

(76) Inventor: Michael Dahl, North Hollywood, CA (US)

Correspondence Address: MICHAEL DAHL, 6616 CLYBOUNE AVE #99, NORTH HOLLYWOOD, CA, 91606, US

(21) Appl. No.: 11/377,479

(22) Filed: Mar. 16, 2006

Related U.S. Application Data
(60) Provisional application No. 60/663,116, filed on Mar. 18, 2005.

(51) Int. Cl. G06K 19/00

(52) U.S. Cl. 235/487

(57) ABSTRACT

This process allows one to create bar code and dot code labels that are sensitive to infrared, visible, and ultraviolet light with out the use of ink. This is accomplished by cutting out or otherwise removing select areas of media to create shapes identical to the outlines of data elements that would be created by infrared, ultraviolet, and visible ink printing systems. This includes but is not limited to the shape of bars in bar coding, the dots in dot coding, lettering, numbering, and images. The method of cutting out the shapes could be manual or with special automated tools, equipment, and machinery. This process offers distinct advantages that qualify it as an improvement over ink printing. It can be done more cheaply, has a stability that is more dependant on the media than the ink, can not wash off, and there are no problems involving insufficient ink and poor print quality.

### CROSS-REFERENCE TO RELATED APPLICATIONS

This application claims the benefit of provisional application 60/663,116 filed on Mar. 18, 2005.

### STATEMENT REGARDING FEDERALLY SPONSERED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This pertains primarily to the field of printing with infrared and ultraviolet inks. The encoding of labels is generally done with the use of ink and printers. Frequently, the requirements are such that the ink is of a special infrared or ultraviolet absorbing type if the labels are to work properly in a given application. The options available to those needing to print with these special inks are limited and expensive. This invention offers an option that may be more desirable to many.

### BRIEF SUMMARY OF THE INVENTION

This process involves removing select areas of media to create shapes identical to the outlines of data elements that would be created by infrared, ultraviolet, and visible ink printing systems. This includes but is not limited to the shape of bars in bar coding, the dots in dot coding, lettering, numbering, and images. The method of cutting out the shapes could be manual or with special automated tools, equipment, and machinery. This process offers distinct advantages that qualify it as an improvement over ink printing. It can be done more cheaply, has a stability that is more dependant on the media than the ink, can not wash off, and there are no problems involving insufficient ink and poor print quality.

This process and article of manufacture is novel and based on sound scientific principals. Though simple, there is little likelihood it would have been known to those learned in the art, or else huge sums of money might not have been invested to develop the ultra violet and infrared printing technologies.

### BRIEF DESCRIPTION OF THE SEVERAL VIEWS OF THE DRAWING

In order to describe the method, it will be helpful to define the ‘critical wavelength’ as the wavelength or band of wavelengths read by a given optical detection device. This critical wavelength may be in the infrared, ultraviolet, or visible light ranges.

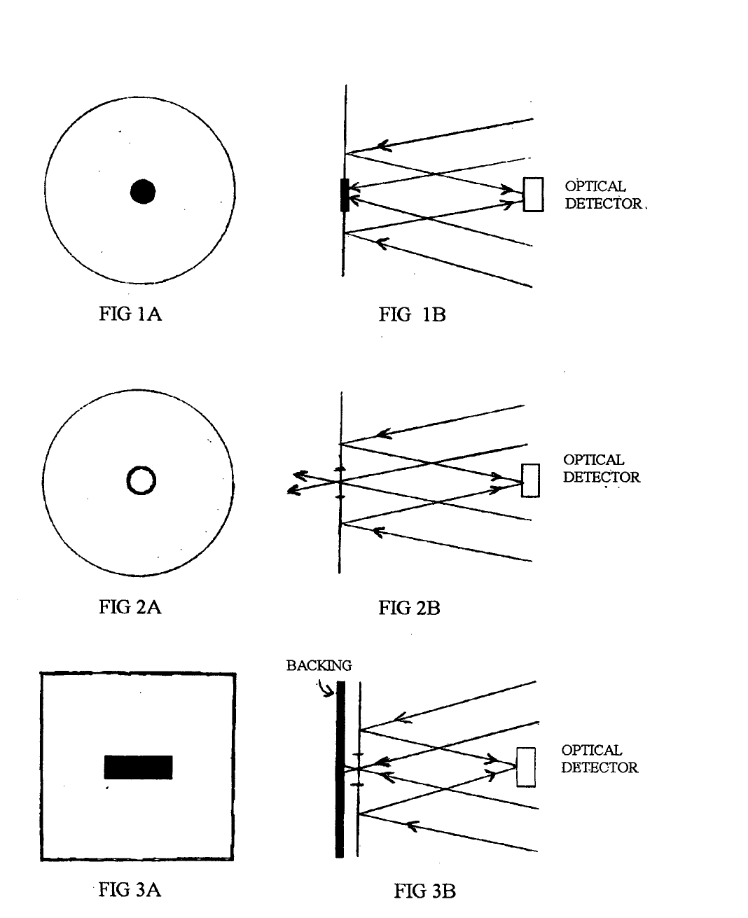

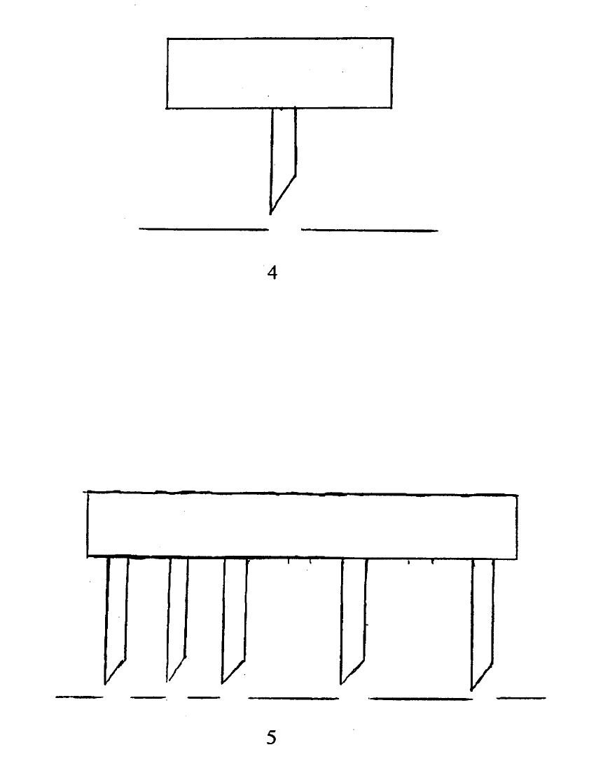

If we take a piece of paper, a label, or similar media that has the property of reflecting the critical wavelength, then place a dot on it using infrared absorbing ink, the dot will absorb the critical wavelength, causing the dot to be recognized by the optical detector (see FIG. 1A, FIG. 1B). If on the other hand we take a piece of paper, a label, or similar media that reflects the critical wavelength and place a hole in it, the hole will also be seen as a dot by optical detectors, provided the backing for the label or other media is of suitable composition. This backing can be anything behind the media, opposite the read surface, that either passes or absorbs the critical wavelength of light. Such a label placed on a glass or plastic bottle, for instance, will generally pass the critical wavelength to yield an image undistinguishable from one created using the more standard ink printing technologies (see FIG. 2A, FIG. 2B). The backing for such a label could in principal be air in which case the critical wavelength of light filling on the data elements would simply pass through. The backing could alternatively be a small area of a cardboard box treated with an appropriate infrared absorbing compound, material, ink, or dye. A label with bars cut out, rather than printed on, could then be placed on the box. The label could then be scanned like a traditional bar code label (see FIG. 3A, FIG. 3B). It does not matter if the critical light passes through the label backing. The labels could be placed on a surface mated with holes to match the punching tool and facilitate cutting (see drawing 4). The shape of the tool's cut or punch may be round, square, rectangular, or whatever is necessary to achieve the desired image. The labels could be placed on a surface mated with holes to match the punching tool and facilitate cutting (see drawing 5).

### DETAILED DESCRIPTION OF THE INVENTION

This process involves removing select areas of media to create shapes identical to the outlines of data elements that would be created by infrared, ultraviolet, and visible ink printing systems, thereby eliminating the need for special inks and printing systems. This includes but is not limited to the shape of bars in bar coding, the dots in dot coding, lettering, numbering, and images. The method of cutting out the shapes could be manual or with special automated tools, equipment, and machinery. This process offers distinct advantages that qualify it as an improvement over ink printing. It can be done more cheaply, has a stability that is more dependant on the media than the ink, can not wash off, and there are no problems involving insufficient ink and poor print quality.

The first embodiment involves punching out holes, squares, bars, and other shapes manually with a tool or tools used as cutting devices designed for the purpose. The labels could be placed on a surface mated with holes to match the punching tool and facilitate cutting (see drawing 4). The shape of the tool's cut or punch may be round, square, rectangular, or whatever is necessary to achieve the desired image. The size of the tools may be varied to achieve the desired result. Since the positioning, spacing, and centering of the data elements may be critical, a template placed either directly over the label or other media, or printed on the media with visible ink may be necessary. Inkjet printing with visible ink for the creation of templates is within easy reach and low in cost. Labels may be used singly, in sheet, or in roll form.

The second embodiment involves a hand tool that can hold many removable, changeable, cutting devices allowing an entire label, page, or other media to be encoded with a single stroke. The labels could be placed on a surface mated with holes to match the punching tool and facilitate cutting (see drawing 5). The shape of the tools may be round, square, rectangular, or whatever is necessary to facilitate achieving the desired image. The size of the tools may be varied to achieve the desired result. Since the positioning, spacing, and centering of the elements may be critical, a template placed either directly over the label or other media, or printed on the media with visible ink may be desirable, but less necessary than with the first embodiment, since the individual punch cutters are precision mounted on the tool itself Inkjet printing with visible ink for the creation of templates is within easy reach and low in cost. Labels may be used singly, in sheet, or in roll form.

The third embodiment consists of an automated, computer or microprocessor controlled device that would punch or cut out unwanted areas of the label or other media according to programmable parameters. The design might involve one or more rows of pins that punch out unwanted areas as the media feeds through the encoding device. The shape of the pins may be round, square, rectangular, or whatever is necessary to facilitate achieving the desired data elements. Positioning of data elements would be precision controlled by the automated encoding system. The size of the pins may be varied to achieve the desired result.

The fourth embodiment involves the use of heat. For example, heated pins acting much like the head on an impact printer could burn the shape of data elements through appropriate media This could be done either manually, or with the aid of an automated computer or microprocessor controlled system.

The fifth embodiment consists of an automated, computer or microprocessor controlled device that would utilize light, probably in the form of lasers to burn out unwanted areas of the label or other media according to programmable parameters. Positioning of data elements would be precision controlled by the automated encoding system. Labels could be fed by sheet or roll.

While this invention has been described in connection with what is presently considered to be the most practical and preferred embodiments, it is to be understood that the invention is not limited to the disclosed embodiments, but on the contrary, is intended to cover various modifications, combinations, and equivalent arrangements included within the spirit and scope of any future claims.

What is claimed here is:

1) A method to encode data onto bar code labels, dot code labels, and other media intended to be scanned by infrared, ultraviolet, and visible light scanners.

2) In connection to claim 1: by removing select areas of media to create shapes identical to the outlines of data elements that would normally be created by infrared, ultraviolet, and visible ink printing systems, scannable images can be created.

3) A device to encode data onto bar code labels, dot code labels, and other media intended to be scanned by infrared, ultraviolet, and visible light scanners, by removing select areas of media to create shapes identical to the outlines of data elements that would normally be created by infrared, ultraviolet, and visible ink printing systems.

4) In connection to claim 3: a device designed to mechanically punch out the shapes of data elements.

5) In connection to claim 3: a device designed to create the shapes of data elements by the use of electrical energy (voltage and current) to burn out the shapes of data elements.

6) In connection to claim 3: a device designed to create the shapes of data elements by the application of sufficient heat or thermal energy to burn out the shapes of data elements.

7) In connection to claim 3: a device designed to create the shapes of data elements by the application of sufficient electromagnetic radiation, such as laser energy.

8) In connection to claim 3: a computer-controlled device to create the shapes of data elements.
